(19) United States
(12) Patent Application Publication
(10) Pub. No.: US 2003/0101224 A1
(43) Pub. Date: May 29, 2003

(54) Automatic e-mail notification method on an executive information system

(76) Inventor: Hung-Liang Chiu, Taipei (TW)

Correspondence Address: BIRCH STEWART KOLASCH & BIRCH, PO BOX 747, FALLS CHURCH, VA, 22040-0747, US

(21) Appl. No.: 09/993,620

(22) Filed: Nov. 27, 2001

(51) Int. Cl. G06F 15/16

(52) U.S. Cl. 709/206; 709/203

(57) ABSTRACT

An automatic e-mail notification method on an Executive Information System (EIS) is disclosed. The disclosed method aims at resolving the problems of passive information transmission on the Executive Information System (EIS). Through this system, deviations during transmission of information can be managed, so that at least one user can be informed of the deviations of the report and automatically receive important messages from e-mail. Users thereby actively obtain strategic information for decision making.

### BACKGROUND OF THE INVENTION

1. Field of the Invention

The invention relates to a method of obsolescent stock management, which is an application of an inventory management system in the manufacturing industry. It includes an automatic notification function through e-mail on an Executive Information System (EIS) that assures that managers are aware of variations in a timely fashion.

2. Related Art

With the booming increase in information, how to filter out relevant information from the overflow of useless information has become a major issue nowadays. Meanwhile, decision makers are overwhelmed with a spate of information, which needs to be integrated, so the present technology to assist them depends on the Executive Information System (EIS). The Executive Information System (EIS) is an information-oriented system specially designed to support decision making for specific managers. Because most of these decision makers are not familiar with applications of information systems, to establish a system that is simple and easy to operate, with graphs or colorful interfaces, has become a most important matter. Moreover, as users of the Executive Information System (EIS) are decision makers of a company, to establish such kind of system must take existing applied computer software and hardware into consideration, so as to save costs and meet computer compatibility requirements. (In the result, what decision-makers require most is strategic information relates to critical success factor.

However, relevant report(s), which are automatically generated on the Executive Information System (EIS), require decision makers to search on the network on their own initiative, or require manual operations to reach specific users. FIG. 1 is a schematic representation of presently known processes in which a user 10 browses report(s) 20, which are generated on the Executive Information System (EIS) 100, through a network browser. However, the Executive Information System (EIS) 100 responds only to requests of the user 10. (again, I don't understand the meaning here) Therefore, the Executive Information System (EIS) 100 does not function to automatically notify the user 10 of generation of report(s) so as to enable the user to search details.

This kind of operation is passive and manual, so it requires extra manpower and time to obtain important information. In view of the confidential information at different levels of decision making, it is impossible to have others to filter out information for decision makers, so that unclassified messages overflowing on the network gradually increase the burden of the network.

Thus, an application method of automatic e-mail notification(s) from the Executive Information System (EIS) to decision makers in the manufacturing industry becomes an issue of concern.

### SUMMARY OF THE INVENTION

In view of the foregoing, the invention of an automatic e-mail notification method on the Executive Information System (EIS) is a solution to enable those decision makers to obtain key information through e-mail once there is any variation of the report(s) on the Executive Information System (EIS) different from pre-defined numbers in the database. Moreover, details of information are stored on the network, within which decision makers are able to search. Transmission of classified and selected information would help to minimize overflow of information of little value as well as to reduce the burden of the network.

The disclosed automatic e-mail notification method on the Executive Information System (EIS) includes at least the following steps: generating report(s) on the Executive Information System (EIS), verifying all identified numbers on those reports by the database, starting up the e-mail program, storing identified numbers on e-mail(s), sending out those e-mails to the user(s), and verifying that the user(s) receive the updated information.

### BRIEF DESCRIPTION OF THE DRAWINGS

The invention will be described in greater detail in the following, for example only, and with reference to the attached drawings, in which:

FIG. 1 shows a schematic representation of presently known operations;

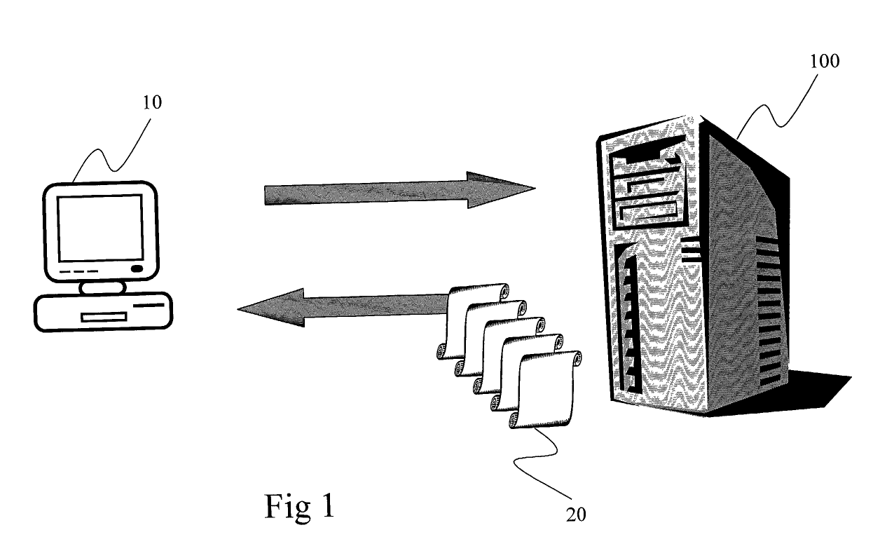

FIG. 2 shows a schematic representation of the auto-operation of sending notification(s) through e-mail(s) on the Executive Information System (EIS); and

FIG. 3 shows a flowchart representation of the method of utilizing the automatic e-mail notification function of the invention on the Executive Information System (EIS) assisting specific managers to make decisions.

### DETAILED DESCRIPTION OF THE INVENTION

The invention proposes an automatic e-mail notification method on the Executive Information System (EIS). In particular, the method, based on the advocacy of the up-to-date Business Process Reengineer (BPR), mainly aims at increasing effectiveness of enterprise resources management and rectifying processes and administration of transmitting information at various levels of decision making to reduce the burden of the network and accelerate the transfer of information. The Executive Information System (EIS) prior to the detailed description of the invention is clarified as follows:

The Executive Information System (EIS) is utilized for filtration and selection of various items of information internally and externally and notifying relevant decision makers of any deviations. The features of the Executive Information System (EIS) are as follows,

1. is specially designed for decision makers;

2. processing key information of extracting, filtering, compressing and tracing;

3. providing on-line processes, supporting trend analysis, and generating variation of reports, etc;

4. integrating a large scope of internal and external information;

5. providing user-friendly interface(s) so as to minimize users' training;

6. is directly used by decision makers; and

7. representing information through graphs, tables, and letters.

The followings must be considered while establishing the Executive Information System (EIS):

1. It requires decision makers to be actively involved in defining required information. Owing to different requirements of different users, the system also needs to re-define and re-assess various factors while being used by particular decision makers.

2. It is necessary to establish specified documents to avoid any conflict or dispute, so as to reduce resistance against changes.

3. Considering the operating experience and assessment of other users, it must be determined whether the system should be a ready-made software package or designed by an outsource contractor.

4. Managing progress of the programming contractor.

5. An ideal Executive Information System (EIS) provides relevant decision makers with additional report(s) or information, which predict variations.

6. Considering response time of the system: in general, information is gathered by batch operation of the system at night in combination with an existing database of information systems to enable users to work in the daytime. This kind of information, though, is not real-time data but has a one-day delay, which enables a quicker response time.

7. Considering flexibility: the system must maintain flexibility and enable user(s) to assemble information when necessary, as the consideration of decision makers may change at any time.

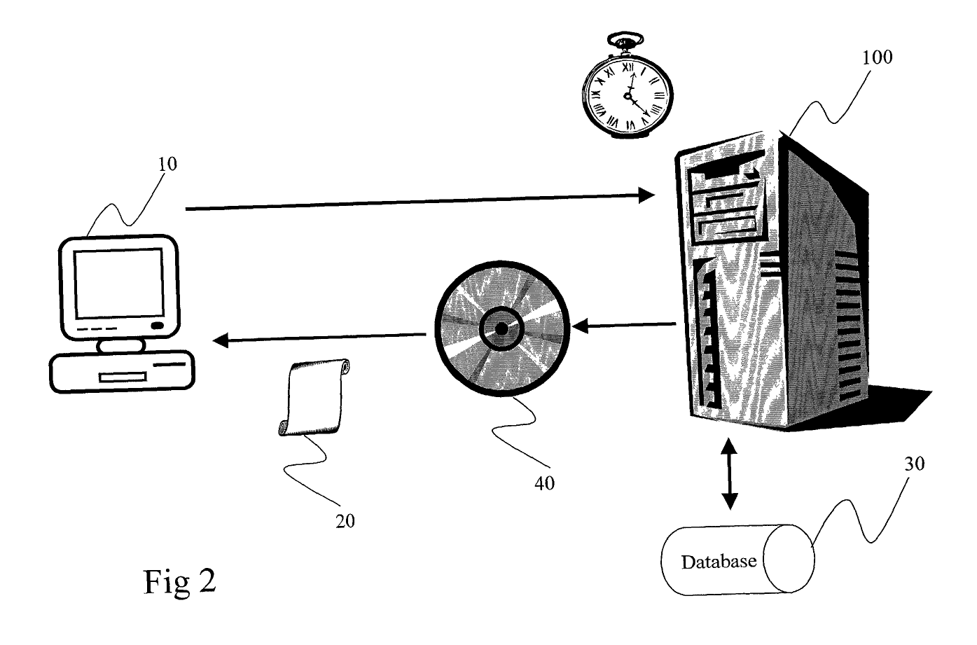

A preferred embodiment is provided below to explain the feasibility of the invention. With reference to FIG. 2, a schematic representation of the automatic e-mail notification method on the Executive Information System (EIS), the Executive Information System (EIS) 100 automatically generates report(s) 20, which are compared with specific number(s) on the database 30 for selecting. After the specific number(s) are checked and selected, the Executive Information System (EIS) 100 calls an e-mail program 40, which sends automatic e-mail(s) with that selected information to notify the user(s) 10 of variation of the report(s). The user(s) 10 may directly click a specific internet address shown on the e-mail to search details of the relevant information. The user(s) 10 are therefore able to analyze detailed information on the network to make proper decisions.

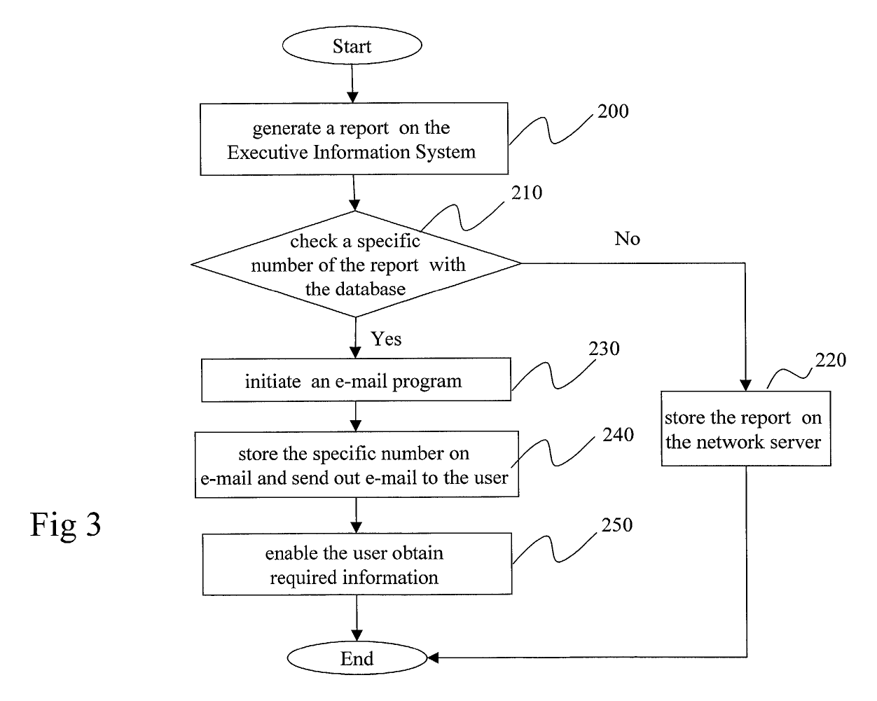

With reference to FIG. 3, a flowchart representation of the method of utilizing the automatic e-mail notification function of the invention for assisting decision making on the Executive Information System (EIS), the Executive Information System (EIS) 100 generates report(s) 20 (step 200), within which pre-defined numbers will be detected by the database 30 (step 210). At first, step 210 needs to determine standardized conditions and objects of the report(s) 20 from the database 30. The sending standards of each report include the following five parameters: name of the report, a checking item, a specific number, the content, and an internet address. In addition, the database 30 also pre-defines the specific number, so that the specific number can be used to verify the variation status from the report 20 if there is any column on the report 20 different from the defined scales or conditions of the database 30. Once there is no change or variation, the system will store the report(s) 20 on a network server (step 220). Otherwise, the system will initiate an e-mail program (step 230), store a specific number on an e-mail and send it out to the user(s) 10 (step 240) so that they will be informed of the updated information (step 250) to end the process.

The above-mentioned report 20 is generated based on a pre-arranged timetable, which is decided by the user 10 of the Executive Information System (EIS) 100. In the meanwhile, the report 20 provides at least one column to record various data attributes and functions.

The above-mentioned database 30 is a structural SQL Server (Structure Query Language Server), which enables the user 10 to browse reports record by record at specific internet addresses, if the user(s) does not use e-mail(s) to obtain information.

While obtaining information, the user(s) 10 automatically receive an e-mail update from the specific Internet address, which can be simply clicked for connecting to the network to search information details. The user 10 automatically obtains information through e-mail, which can be operated by any receiving/sending units of a computer controlled hardware platform, such as a PC (Personal Computer), an NB (Notebook or laptop), a PDA (Personal Digital Assistant), or a WAP (Wireless Application Protocol) mobile phone.

The invention in the form of the automatic e-mail notification method on the Executive Information System (EIS) has been described herein. These and other variations, which will be understood by those skilled in the art, are within the intended scope of the invention as claimed below. As previously stated, detailed embodiments of the invention are disclosed herein; however, it is to be understood that the disclosed embodiments are merely exemplary of the invention that may be embodied in various forms.

What is claimed is:

1. An automatic e-mail notification method on the Executive Information System (EIS) is applied for transmission of information in the manufacturing industry to monitor deviation status of the report and inform the user of the status by e-mail, so that the user will actively obtain most updated and real-time information in efficiency.. The method at least includes the steps of:
Generating a report on the Executive Information System (EIS);
Detecting a specific number of the report from the database;
Starting up an e-mail program, if there is any variation from the report;
Storing the specific number on e-mail and sending notification to the user; and
Enabling the user obtain information in a timely fashion.

2. The method of claim 1, wherein the Executive Information System refers to the system that is applied to filter out selected internal/external information and provide the user with deviation situation on the report, for awareness of relevant decision makers.

3. The method of claim 1, wherein the report are generated on the Executive Information System by a pre-scheduled time, which is determined by the user.

4. The method of claim 1, wherein the report provides more than one column to record various data attributes and functions.

5. The method of claim 1, wherein the steps of detecting the specific numbers of the report by the database refer to the first step, which needs to verify standardized conditions and objects of the sending report.

6. The method of claim 5, wherein the standardized conditions of sending the report(s) at least include: name of the report, a checking item, a specific number, the content, and an internet address.

7. The method of claim 1, wherein the specific number is to evaluate variation status if any column on the report differs from pre-defined scale of conditions of the database.

8. The method of claim 1, wherein the database is a SQL(Structured Query Language) Server.

9. The method of claim 1, wherein the user(s) can browse the report(s) details record by record on the specific internet

10. The method of claim 1, wherein the user(s) obtain information further comprises the following steps of:
Obtaining information by automatically receiving e-mail notifications, so as to clicking a specific internet address on the e-mail;
Connecting to the network; and
Searching for details of information.

11. The method of claim 10, wherein the user automatically obtains information through e-mails, which can be operated by any receiving/sending units of computer controlled hardware platform, such as a PC (Personal Computer), a NB (Notebook or laptop), a PDA (Personal Digital Assistant), and a WAP (Wireless Application Protocol) mobile phone.
